(19) United States
(12) Patent Application Publication
(10) Pub. No.: US 2014/0167439 A1
(43) Pub. Date: Jun. 19, 2014

(54) VEHICLE CARGO BED EXTENDER

(71) Applicant: Kris Sorensen, Lehi, UT (US)

(72) Inventor: Kris Sorensen, Lehi, UT (US)

(73) Assignee: Kris Sorensen, Lehi, UT (US)

(21) Appl. No.: 13/714,978

(22) Filed: Dec. 14, 2012

(51) Int. Cl. B60R 9/06

(52) U.S. Cl. CPC B60R 9/06
USPC 296/26.11

(57) ABSTRACT

A vehicle cargo bed extension device useable to increase the load size capacity of a vehicle cargo bed. The vehicle cargo bed extension device includes a hinge to allow for support frame rotation. Additionally, the support frame can be adjusted horizontally and vertically in relation to a vehicle cargo bed.

### BACKGROUND OF THE INVENTION

The present invention relates generally to a cargo bed extension device for vehicles, and in particular to an extension device that is attachable at the rear of a vehicle-towing receiver and adjustable to match any type of pick-up truck.

The prior art describes numerous cargo bed extension devices for vehicles such as pick-up trucks. Generally, these devices are supported at the rear of a lowered tailgate, using a support mechanism that is mounted on a hitch retainer. Normally, the extension device is comprised of a rectangular deck having a width substantially equal to the width of the vehicle cargo bed or at least a vehicle's inner fender area, and a deck support to hold the deck in the desired position, when a horizontal hitch attachment post is inserted into the hitch retainer.

Prior art vehicle cargo bed extension devices are not entirely satisfactory, however, in that they are not adjustable to match different tailgate lengths and heights. Additionally, prior art vehicles are bulky when stored and will not collapse to a smaller size. Thus, there is a need for a vehicle cargo bed extension device that is adjustable to different truck sizes and collapses to a small size when stored.

### SUMMARY OF THE INVENTION

Embodiments of an apparatus are described. In one embodiment, the apparatus is a cargo bed extender comprising an extension arm wherein a first end of the extension arm is configured to fit inside a receiver hitch and the extension is configured to fasten at multiple positions along the extension arm to the receiver hitch. A sleeve is coupled to a second end of the extension arm wherein the sleeve and the extension arm are configured to fasten at multiple positions along the extension arm and along the sleeve. A hinge is coupled to the sleeve and a support frame is coupled to the hinge. Other embodiments of the apparatus are also described.

Embodiments of an apparatus are also described. In one embodiment, the apparatus is a cargo bed extender comprising an extension arm comprising a first arm and a second arm wherein the first arm is perpendicular to the second arm and the first arm has a first plurality of holes and the second arm has a second plurality of holes. Further a sleeve is coupled to the second arm wherein the sleeve has a third plurality of holes A hinge is coupled to the sleeve; and a support frame is coupled to the hinge. Other embodiments of the apparatus are also described.

Embodiments of an apparatus are also described. In one embodiment, the apparatus is a cargo bed extender comprising an extension arm comprising a first arm and a second arm wherein the first arm is perpendicular to the second arm and the first arm has a first plurality of holes and the second arm has a second plurality of holes. Further, a first eyelet is coupled to the extension arm. A sleeve is coupled to the second arm wherein the sleeve has a third plurality of holes. A hinge is coupled to the sleeve and a support bar is coupled to the hinge. A rectangular support frame is coupled to the support bar wherein the rectangular support frame is configured with a lip around a perimeter of the rectangular support frame. A first insert and a second insert are configured to fit inside the lip of the rectangular support frame.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a side view of the cargo bed extender for one embodiment.

FIG. 2 depicts a perspective view of the cargo bed extender for one embodiment.

FIG. 3 depicts a perspective view of the cargo bed extender for one embodiment.

FIG. 4 depicts a side view of the cargo bed extender for one embodiment.

FIG. 5 depicts a side view of the cargo bed extender for one embodiment.

FIG. 6 depicts a side rail extended flat for one embodiment.

FIG. 7 depicts a top view of the cargo bed extender support frame for one embodiment.

Throughout the description, similar reference numbers may be used to identify similar elements.

### DETAILED DESCRIPTION

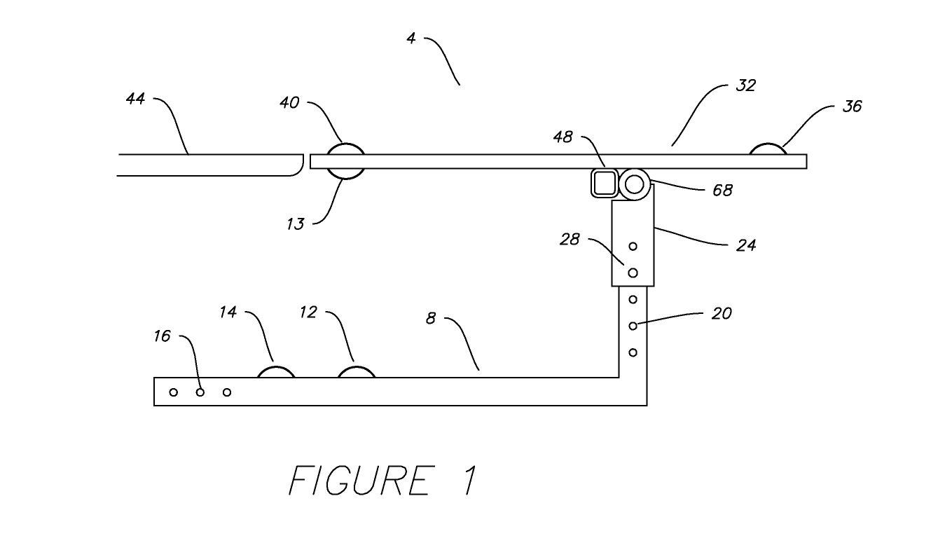

FIG. 1 depicts a side view of the cargo bed extender for one embodiment.

Cargo bed extender 4 comprises extension arm 8. Extension arm 8 has eyelet 12 and 14 and has receiver holes 16 and height adjustment holes 20. Sleeve 24 has sleeve holes 28 and is connected to hinge 68 which allows support bar 48 to rotate. Receiver holes 16, height adjustment holes 20, and sleeve holes 28 are drilled completely through extension arm 8 and sleeve 24 such that a pin can slide completely through. Hinge 68 is connected to support bar 48 which is connected to support frame 32. Eyelet 13, 40, and eyelet 36 are connected to support frame 32. Truck tailgate 44 is lowered to form a flat plane with support frame 32.

Cargo bed extender 4 can be made of any suitable material with the capacity of supporting the cargo placed on the cargo bed extender 4. In one embodiment, the extension arm 8 is made of tubular metal material sized to fit inside a receiver hitch. In one embodiment, Eyelet 12 is welded to extension arm 8. Receiver holes 16, adjustment holes 20, and sleeve holes 28 are sized to fit a hitch pin. Sleeve 24 is sized to fit over extension arm 8. Hinge 68 can be any type of hinge suitable for supporting the weight placed on the cargo extender. Support bar 48 is sized to support the weight of cargo placed on cargo extender 4. In one embodiment support frame 32 is made from one inch angel iron welded together to form a rectangle. Eyelet 40 and eyelet 36 are welded to support frame 32.

Cargo bed extender operates by inserting extension arm 8 into a hitch receiver. One of the receiver holes 16 are aligned with the hitch receiver hole such that support frame 32 is positioned close to the truck tailgate 44. The different hole locations allow the cargo bed extender 4 to move horizontally to fit with multiple truck tailgate lengths.

Sleeve 24 fits over extension arm 8. Adjustment holes 20 and sleeve holes 28 are aligned such that a pin can be inserted through both holes. The different hole locations in extension arm 8 and sleeve 24 allow the cargo bed extender 4 to move vertically with relation to truck tailgate 44. This allows the support frame 32 to match the elevation of the truck tailgate 44 for multiple hitch receiver and truck tailgate elevation differences.

Sleeve 24 can be completely separated from extension arm 8 when not in use. Hinge 68 allows sleeve 24 to rotate so that it is parallel with support frame 32. This allows cargo bed extender 4 to stored with minim space requirements. For example, the cargo bed extender 4 can be laid flat in the back of a pickup truck.

Eyelets 40, 36, 13, 14 and 12 can be used to further secure the cargo bed extender to a vehicle or to strap down the additional cargo carried by the cargo bed extender. Eyelets 12 and 14 can be connected to eyelet 13 by a strap to prevent support frame 32 from rotating on hinge 68.

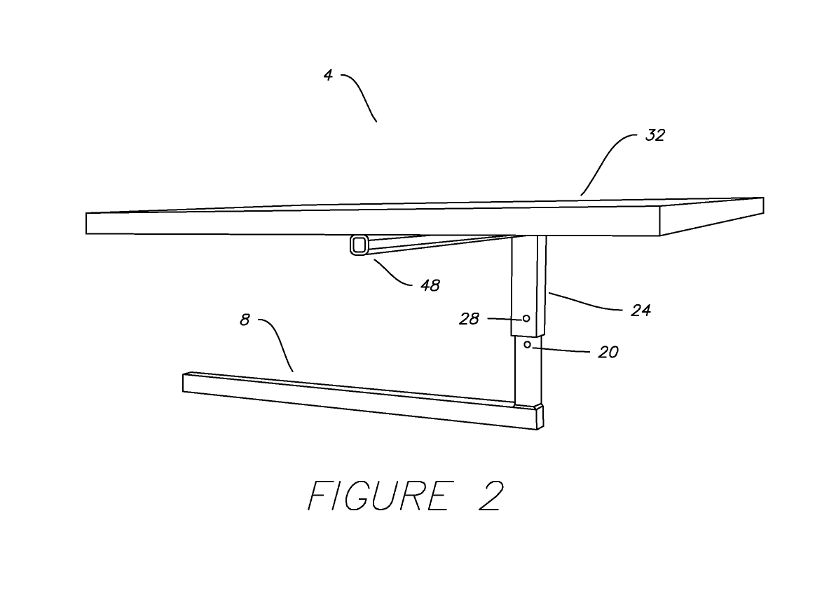

FIG. 2 depicts a perspective view of the cargo bed extender for one embodiment.

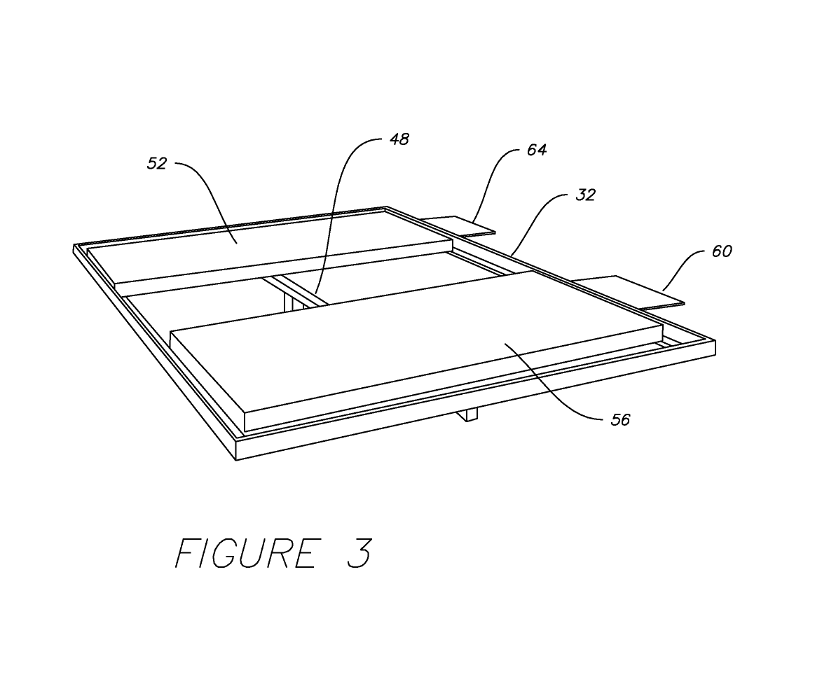

FIG. 3 depicts a perspective view of the cargo bed extender for one embodiment. Insert 52 and insert 56 may be inserted in support frame 32 to provide a platform to hold cargo. A lip around support frame 32 prevents insert 52 and insert 56 from horizontal movement. In one embodiment insert 52 and insert 56 can be permanently attached to support frame 32.

Support plate 60 and support plate 64 are attached to support frame 32. Support plate 60 and support plate 64 prevent hinge 68 from rotating support frame 32 below truck tailgate 44.

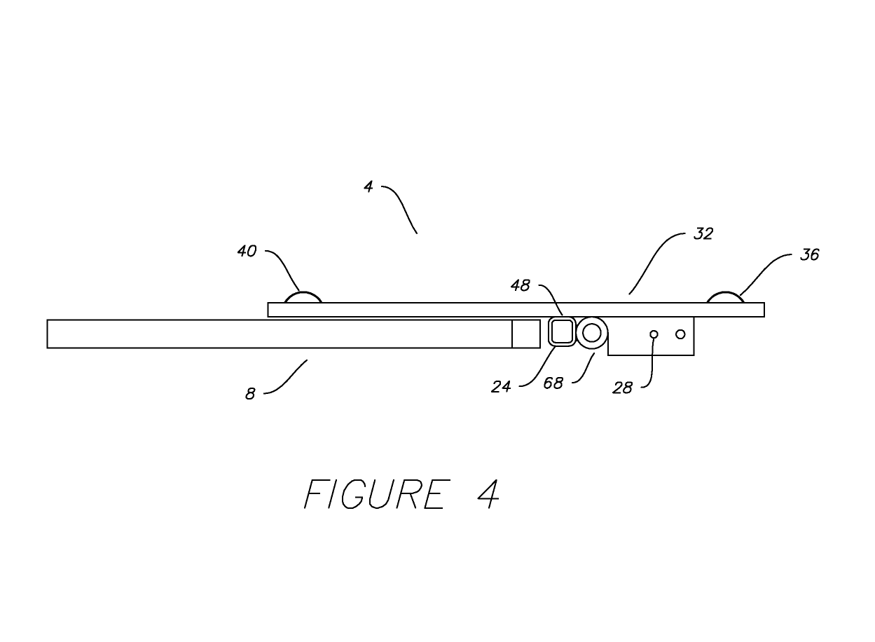

FIG. 4 depicts a side view of the cargo bed extender 4 for one embodiment. FIG. 4 shows extension arm 8 removed from sleeve 24. Extension arm 8 is placed on its side to reduce storage requiems for the cargo bed extender 4.

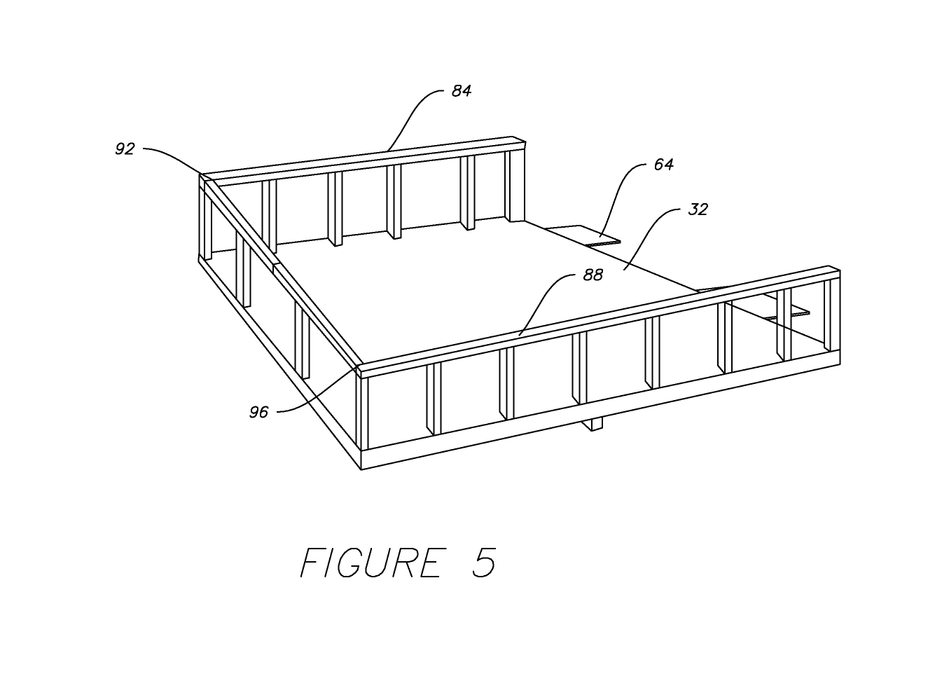

FIG. 5 depicts a side view of the cargo bed extender for one embodiment. Side rails 84 and 88, can be attached to support frame 32 to eyelets 38 and 40. Side rails 84 and 88 have hinges 92 and 96 that allow side rails 84 and 88 to extend flat when they are removed from support frame 32. When Side rails 84 and 88 are extended flat they can be used as a ramp to wheel a vehicle onto support frame 32.

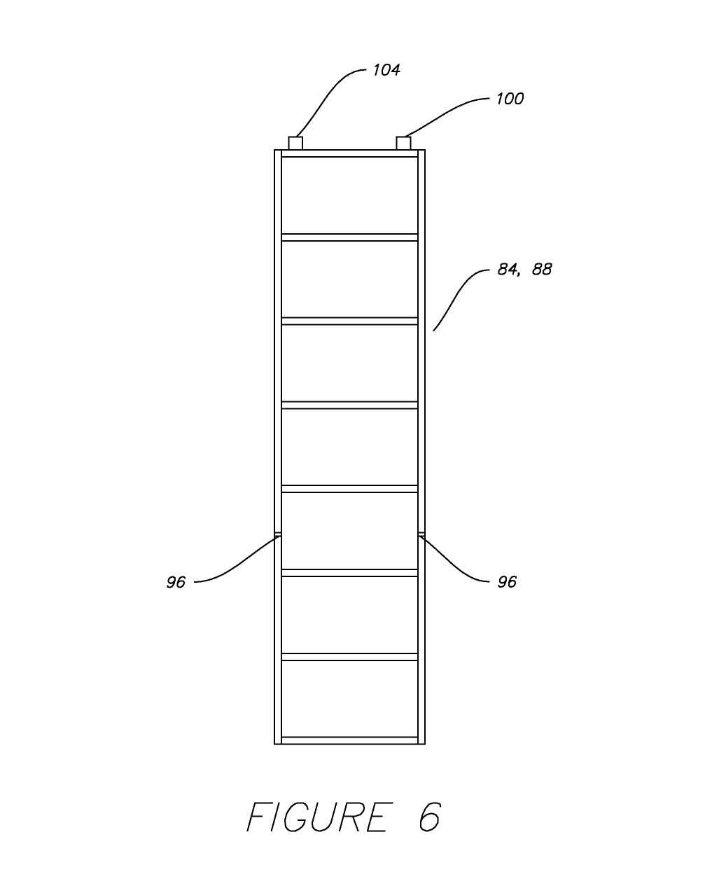

FIG. 6 Shows a side rail extended flat. Support angles 100 and 104 hook onto on support frame 32 to create a ramp for the vehicle.

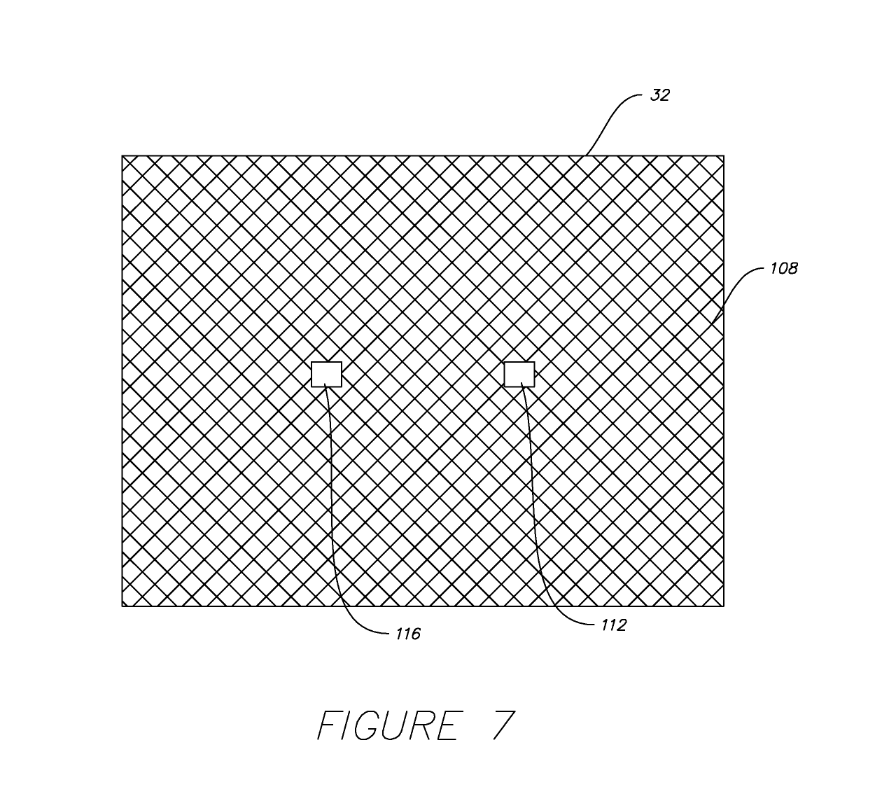

FIG. 7 depicts a top view of the cargo bed extender support frame for one embodiment. Support mesh 108 can be permanently attached to support frame 32. Hand holes 112 and 116 are used for lifting support frame 32.

The cargo bed extender 4 can be adjusted horizontally to match multiple tailgate lengths and adjusted vertically to match multiple distances from the hitch receiver to the tailgate. The cargo bed extender 4 is superior to existing cargo racks because one rack can be adapted to fit a variety of vehicles and does not require a different rack for each type of vehicle.

Additionally, the cargo bed extender 4 can be disassembled for minimal storage space. Existing cargo racks remain in their bulky and awkward position when they are stored and do not lie flat. The cargo bed extender 4 can lie flat in the back of a vehicle cargo bed.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A cargo bed extender comprising:
an extension arm wherein a first end of the extension arm is configured to fit inside a receiver hitch and the extension is configured to fasten at multiple positions along the extension arm to the receiver hitch;
a sleeve coupled to a second end of the extension arm wherein the sleeve and the extension arm are configured to fasten at multiple positions along the extension arm and along the sleeve;
a hinge coupled to the sleeve;
a support frame coupled to the hinge.

2. The cargo bed extender of claim 1 wherein the hinge is configured to allow the sleeve to rotate parallel to the support frame.

3. The cargo bed extender of claim 1 wherein the extension arm is configured to be removed from the sleeve.

4. The cargo bed extender of claim 1, wherein the support frame is configured to securely hold a first insert and a second insert.

5. The cargo bed extender of claim 1 further comprising a means for preventing the support frame from rotating below a truck tailgate.

6. A cargo bed extender comprising:
an extension arm comprising a first arm and a second arm wherein the first arm is perpendicular to the second arm and the first arm has a first plurality of holes and the second arm has a second plurality of holes;
a sleeve coupled to the second arm wherein the sleeve has a third plurality of holes;
a hinge coupled to the sleeve; and
a support frame coupled to the hinge.

7. The cargo bed extender of claim 6 wherein the first plurality of holes allows the extension arm to fasten in multiple horizontal positions in relation to a receiver hitch.

8. The cargo bed extender of claim 6 wherein the second plurality of holes allows the extension arm to fasten in multiple vertical positions in relation to the sleeve.

9. The cargo bed extender of claim 6 wherein the third plurality of holes allows the sleeve to fasten in multiple vertical positions in relation to the extension arm.

10. The cargo bed extender of claim 7 wherein the second plurality of holes allows the extension arm to fasten in multiple vertical positions in relation to the sleeve.

11. The cargo bed extender of claim 10 wherein the third plurality of holes allows the sleeve to fasten in multiple vertical positions in relation to the extension arm.

12. The cargo bed extender of claim 11 wherein the hinge is configured to allow the sleeve to rotate parallel to the support frame.

13. A cargo bed extender comprising:
an extension arm comprising a first arm and a second arm wherein the first arm is perpendicular to the second arm and the first arm has a first plurality of holes and the second arm has a second plurality of holes;
a first eyelet coupled to the extension arm;
a sleeve coupled to the second arm wherein the sleeve has a third plurality of holes;
a hinge coupled to the sleeve;
a support bar coupled to the hinge;
a rectangular support frame coupled to the support bar wherein the rectangular support frame is configured with a lip around a perimeter of the rectangular support frame;
a first insert and a second insert configured to fit inside the lip of the rectangular support frame.

14. The cargo bed extender of claim 13 wherein the first plurality of holes allows the extension arm to fasten in multiple horizontal positions in relation to a receiver hitch.

15. The cargo bed extender of claim 14 wherein the third plurality of holes allows the sleeve to fasten in multiple vertical positions in relation to the extension arm.

16. The cargo bed extender of claim 15 wherein the second plurality of holes allows the extension arm to fasten in multiple vertical positions in relation to the sleeve.

17. The cargo bed extender of claim 16 wherein the third plurality of holes allows the sleeve to fasten in multiple vertical positions in relation to the extension arm.

18. The cargo bed extender of claim 17 wherein the hinge is configured to allow the sleeve to rotate parallel to the support frame.
